(19) United States
(12) Patent Application Publication
(10) Pub. No.: US 2022/0247254 A1
(43) Pub. Date: Aug. 4, 2022

(54) Electric Machine Having a Plastic Body

(71) Applicant: ZF Friedrichshafen AG, Friedrichshafen (DE)

(72) Inventors: Timo Wehlen, Friedrichshafen (DE); Eckhardt Lübke, Friedrichshafen (DE); Andreas Hölscher, Uhldingen-Mühlhofen (DE); Martin Jelinewski, Nonnenhorn (DE); Manfred Till, Friedrichshafen (DE)

(21) Appl. No.: 17/602,555

(22) PCT Filed: Mar. 4, 2020
(86) PCT No.: PCT/EP2020/055638

§ 371 Date: Oct. 8, 2021

(30) Foreign Application Priority Data
Apr. 23, 2019 (DE) 10 2019 205 751.9

(51) Int. Cl. H02K 5/08; H02K 1/20; H02K 5/20

(52) U.S. Cl. CPC H02K 5/08; H02K 5/203; H02K 1/20

(57) ABSTRACT

An electric machine (1) includes a multi-piece housing (2), a stator (4) stationarily accommodated at the housing (2) by a plastic body (3), and a rotor (5) arranged radially within the stator (4). The plastic body (3) is electrically insulating and surrounds at least one electrical line (17a, 17b, 17c) configured for conducting an electric current between a power electronics unit of the electric machine (1) and the stator (4). At least one channel (8), which is configured for accommodating a coolant, is formed in the plastic body (3). A flange-shaped section (3a) of the plastic body (3) is formed axially between a first housing cover (2a) and a housing shell section (2c) of the multiple-piece housing (2). The at least one electrical line (17a, 17b, 17c) and the at least one channel (8) are formed in the flange-shaped section (3a).

### CROSS-REFERENCE TO RELATED APPLICATIONS

The present application is related and has right of priority to German Patent Application No. 102019205751.9 filed in the German Patent Office on Apr. 23, 2019 and is a nationalization of PCT/EP2020/055638 filed in the European Patent Office on Mar. 4, 2020, both of which are incorporated by reference in their entirety for all purposes.

### FIELD OF THE INVENTION

The invention relates generally to an electric machine having a multiple-piece housing, a stator stationarily accommodated at the housing by a plastic body, and a rotor arranged radially within the stator, wherein at least one channel, which is provided for accommodating a coolant, is formed in the plastic body.

### BACKGROUND

DE 10 2013 201 758 A1 describes an electric machine having a housing and a stator accommodated at the housing, a rotor arranged radially within the stator, and a cooling device between the stator and the housing. At least one plastic body surrounds a soft magnetic core of the stator radially on the outside, wherein at least one indentation of the cooling device guiding a cooling medium is at least partially introduced in the outer lateral surface of the at least one plastic body.

### SUMMARY OF THE INVENTION

Example aspects of the present invention provide an electric machine having improved cooling.

An electric machine according to example aspects of the invention includes a housing formed as multiple pieces, a stator stationarily accommodated at the housing by a plastic body, and a rotor arranged radially within the stator. The plastic body is electrically insulating and surrounds at least one electrical line, which is configured for conducting an electric current between a power electronics unit of the electric machine and the stator. At least one channel, which is provided for accommodating a coolant, is formed in the plastic body. A flange-shaped section of the plastic body is formed axially between a first housing cover and a housing shell section of the multiple-piece housing and the at least one electrical line as well as the at least one channel are formed in the flange-shaped section.

The flange-shaped section of the plastic body is utilized for connecting the first housing cover and the housing shell section to each other and for forming an area, which is configured, in particular, for supporting the torque of the stator at the housing and, simultaneously, also for cooling the at least one electrical line.

The electrically insulating plastic body is preferably manufactured using an injection molding process or is made of a molding compound and, furthermore, is configured for electrically insulating, sealing off, and cooling—via a coolant flow in the at least one channel—the electrically conductive components of the stator, and supporting the stator at the housing in such a way that further stator carriers are unnecessary.

For example, a single channel is formed in the plastic body, which guides coolant and cools at least one electrical line, preferably all electrical lines, of the stator. Alternatively, multiple channels can be formed in the plastic body, which guide coolant and cool at least one electrical line, preferably all electrical lines, of the stator. The at least one electrical line extends, together with the at least one channel, through the flange-shaped section, wherein the at least one channel is guided around the at least one electrical line over a large area in order to increase the cooling capacity. In particular, the at least one electrical line emerges from the plastic body at the flange-shaped section.

Preferably, the at least one channel is guided—at least partially/in sections or completely—along all electrical lines that are connected to the stator, in order to cool the stator. Preferably, the at least one electrical line is designed as a copper rail, a copper wire, or a flat copper component. In particular, the electric machine is designed as a 3-phase motor (UVW motor) and is provided for use as a prime mover for a motor vehicle, and so three electrical lines are provided with alternating current for operating the electric machine. A power electronics unit is to be understood to be a device that controls the operation, in particular the energization, of the stator by way of an open-loop system and a closed-loop system. In particular, the power electronics unit includes an inverter, which is configured for converting DC voltage into AC voltage.

According to one preferred example embodiment of the invention, the housing formed as multiple pieces includes at least the first housing cover and the housing shell section. Additionally, the housing formed as multiple pieces can also include a second housing cover. The housing shell section is designed to be essentially hollow-cylindrical and is axially arranged between the two housing covers. In particular, the housing shell section is configured for completely accommodating the stator in the radial direction. The particular housing cover is provided for coming to rest at least against the housing shell section, in order to delimit the housing in the axial direction.

Preferably, the flange-shaped section is axially preloaded, circumferentially, between the first housing cover and the housing shell section. Consequently, an axial load circumferentially acts at the first housing cover, at the housing shell section, and at the flange-shaped section in such a way that the three components (the first housing cover, the housing shell section, and the flange-shaped section) undergo a compression. Due to the compression or axial preload, seal faces are formed between the first housing cover and the flange-shaped section of the plastic body and between the housing shell section and the flange-shaped section of the plastic body, which implement a fluidic sealing of the at least one channel in these areas, and so coolant cannot escape from the at least one channel. In particular, the axial preload between the first housing cover, the housing shell section, and the flange-shaped section can be adjusted in such a way that a hydraulic pressure of the coolant is taken into account.

Preferably, the flange-shaped section includes multiple axial passages for screws, wherein each passage is formed coaxially to a particular bore hole in the first housing cover and a particular bore hole in the housing shell section. In particular, a metallic sleeve is situated in each passage, wherein the particular bore hole in the housing shell section has a thread for the screwing-in of the screws. Preferably, five screws are provided for the form-locking connection of the first housing cover to the housing shell section and the flange-shaped section of the plastic body arranged axially between the first housing cover and the housing shell section. Alternatively, the passages in the flange-shaped section may be omitted and may accommodate the flange-shaped section in a form-locking manner between the housing cover and the housing shell section, wherein the housing cover and the housing shell section are screwed together by multiple screws.

In particular, the at least one channel is designed as an indentation in an outer surface of the plastic body. Preferably, the at least one channel is designed as an indentation in both end faces and one lateral surface of the plastic body. For example, indentations at the end face of the plastic body are fluidically connected via bore holes or recesses in the plastic body to indentations or channels in the interior of the plastic body. The formation of the at least one channel at outer surfaces of the plastic body makes it possible to use simple as well as fast manufacturing processes, since the processing of the plastic body takes place essentially from the outside.

Preferably, the at least one channel is axially formed in an end face of the plastic body and is configured for guiding the coolant between the first housing cover and the plastic body. Moreover, it is preferred when the at least one channel is radially formed in an outer circumferential surface of the plastic body and is configured for guiding the coolant between the first housing cover and a housing top or cap. In particular, the channel formed at the end faces is fluidically connected via a recess to the channel formed on the circumference.

According to one preferred example embodiment of the invention, the at least one channel is formed in the plastic body in such a way that the at least one electrical line is surrounded on two sides, at least partially or in sections, by the at least one channel. In particular, three electrical lines are provided, wherein the at least one channel is initially guided along the three lines at a first side, has a curvature of one hundred and eighty degrees (180°) and, for example, is guided along the three lines in parallel to the front section of the channel at a second side in the rear section of the channel. Consequently, the electrical lines are cooled on both sides and over a large area.

Preferably, the at least one electrical line protrudes radially from the flange-shaped section, wherein the plastic body at least partially encases the at least one electrical line in this area. Due to the encasing of the at least one electrical line in the area of a protrusion from the plastic body, the at least one electrical line is supported and insulated, and so further parts for support and insulation can be omitted, as the result of which, in particular, the installation effort can be reduced.

Preferably, three electrical lines protrude radially from the flange-shaped section, wherein, in this area, the plastic body separately encases each of the three electrical lines. Consequently, the plastic body is designed, with respect to the protrusion of the electrical lines from the flange-shaped section, in such a way that each electrical line is encased individually and separately from one another and the lines are not connected to one another in this area. In particular, weight can be saved as a result.

Advantageously, furthermore, the plastic body surrounds a soft magnetic core of the stator as well as first and second winding overhangs of the stator at the end faces and radially on the outside. Consequently, the soft magnetic core and the first and second winding overhangs of the stator are also encased by the plastic body at the end faces and radially on the outside. In particular, the winding overhangs are completely embedded in the plastic body. Therefore, the stator is preferably completely extrusion-coated with the plastic body except for an inner circumferential surface. The stator is formed from the soft magnetic core and windings and is configured for generating an electromagnetic field. The windings are formed, in particular, from copper wires and have winding overhangs at the ends, toward each end face of the stator, namely the first winding overhangs at the first end face, i.e., at a first axial end of the stator, and the second winding overhangs at the other end face, i.e., at a second axial end of the stator. The soft magnetic core of the stator is arranged axially between the first winding overhangs and the second winding overhangs.

Due to the cooling of the winding overhangs at the end faces as well as radially on the outside at both ends of the stator as well as the radially outer cooling of the soft magnetic core, a large amount of waste heat is removed via the coolant and, as a result, the stator is efficiently cooled. As a result, the continuous input power of the electric machine can be increased. A typical stator cooling jacket is not necessary, as the result of which costs, weight, and installation space can be saved. In particular, a noise decoupling between the stator and the housing takes place via the plastic body. In particular, the electric machine is provided for being connected, at the end faces, to the transmission. Due to the cooling at both end faces of the electric machine, a cooling of a transmission wall of a transmission arranged at one end face of the electric machine also takes place.

For example, the at least one channel is formed, at least partially circumferentially, along one end face of the first winding overhangs, wherein, furthermore, the at least one channel is formed, repeatedly circumferentially, along an outer circumferential surface of the stator, and wherein the at least one channel is formed, at least partially circumferentially, along one end face of the second winding overhangs. Consequently, it is preferably provided to guide the coolant through the at least one channel at least partially circumferentially along the end face of the first winding overhangs, repeatedly circumferentially over the outer circumferential surface of the stator, and at least partially circumferentially along the end face of the second winding overhangs, in order to efficiently cool the stator of the electric machine. In certain example aspects, it is essential to also cool the first and second winding overhangs at the end faces in order to increase the cooling capacity of the electric machine. Moreover, such a design of the at least one channel prevents the formation of dead water zones and enables an efficient coolant flow.

Preferably, an axial width of the at least one channel at the outer circumferential surface of the stator is at least three (3) times as large as a radial depth of the at least one channel at the outer circumferential surface of the stator. Consequently, the at least one channel is designed to be wide and flat at the outer circumferential surface of the stator. For example, the axial width of the at least one channel at the outer circumferential surface of the stator is five (5) times as large as the radial depth of the at least one channel at the outer circumferential surface of the stator. This improves, in particular, the cooling of the electric machine.

In particular, the at least one channel is helically formed along the outer circumferential surface of the stator. Moreover, it is also conceivable, however, to form at least one channel as meandering or curved. The at least one channel can also include channel sections designed to be axial as well as parallel or can be divided into two half-flows. A combination of the aforementioned forms as well as further arbitrary forms is also conceivable.

Preferably, an inflow for the coolant is formed at the end face of the first winding overhangs, wherein an outflow for the coolant is formed at the end face of the second winding overhangs. At the inflow, the coolant has the lowest temperature and, thereby, the highest cooling power, because the coolant has not yet absorbed any waste heat from the stator. In particular, the temperature at the first winding overhangs during the operation of the electric machine is higher than the temperature at the second winding overhangs. The coolant is preferably water-based. An inflow connection geometry, for example, an inlet opening, and an outflow connection geometry, for example, an outlet opening, can be designed to be radial or axial, in order to generate installation space advantages. An inflow for the coolant is understood to mean lines or geometries that make it possible for coolant to flow into the at least one channel. Moreover, an outflow for the coolant is understood to mean lines or geometries that make it possible for coolant to flow out of the at least one channel.

Preferably, the at least one channel has a larger volume for coolant at the first winding overhangs than the at least one channel at the second winding overhangs. In particular, the electrical lines are arranged at the first winding overhangs, and so a higher cooling power is generated there by the larger volume for coolant.

Preferably, the plastic body has thermally conductive fillers. In particular, metallic fillers having a high thermal conductivity, for example, copper or aluminum particles, are arranged in the plastic body in such a way that an electrical insulation of the plastic is maintained. Moreover, the plastic body can also be furnished with ceramic particles, for example, with metal oxides, in order to increase the thermal conductivity.

### BRIEF DESCRIPTION OF THE DRAWINGS

Three preferred exemplary embodiments of the invention are explained in greater detail in the following with reference to the drawings, in which

FIG. 1 shows a perspective schematic of an electric machine according to a first exemplary embodiment of the invention,

FIG. 2 shows an exploded schematic of a portion of the electric machine according to the first exemplary embodiment,

FIG. 3 shows a detailed schematic of a cutout of the electric machine according to the first exemplary embodiment,

FIG. 4 shows a half-section schematic of the electric machine according to the first exemplary embodiment,

FIG. 5 shows a perspective schematic of a cutout of the electric machine according to a second exemplary embodiment,

FIG. 6 shows an end-face schematic of the electric machine according to the second exemplary embodiment,

FIG. 7 shows a perspective schematic of the electric machine according to the second exemplary embodiment, and

FIG. 8 shows a detailed schematic of a cutout of the electric machine according to a third exemplary embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

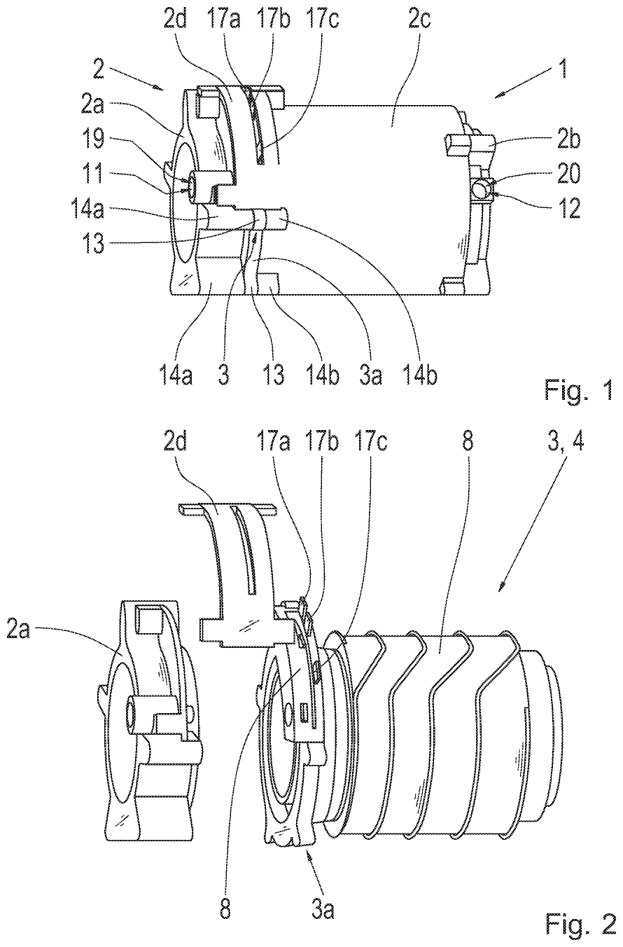

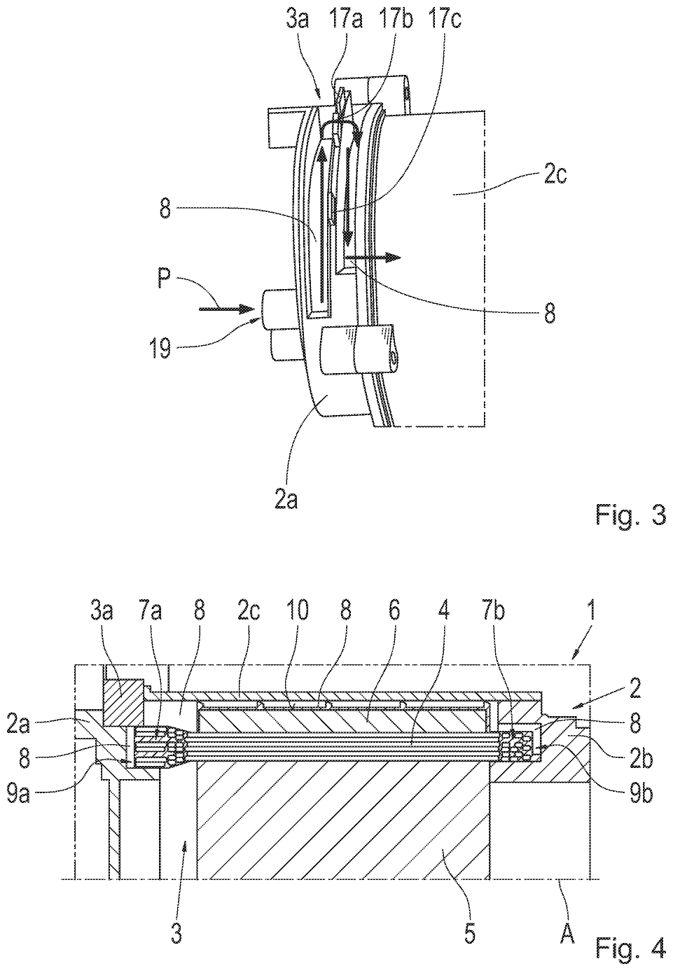

In FIG. 1, FIG. 2, FIG. 3, and FIG. 4, a first exemplary embodiment of the electric machine 1 is represented. According to FIG. 1, the electric machine 1 according to example aspects of the invention has a housing 2 formed as multiple pieces, which includes a first housing cover 2a and a second housing cover 2b, a housing shell section 2c, and a housing top or cap 2d. A stator 4 and a rotor 5 arranged radially within the stator 4 are accommodated in the housing 2. The stator 4 is extrusion-coated by a plastic body 3 (see FIG. 4). The plastic body 3 is electrically insulating and has a flange-shaped section 3a, which is arranged axially between the first housing cover 2a and the housing shell section 2c of the multiple-piece housing 2 and accommodates three electrical lines 17a, 17b, 17c as well as a channel 8, which is provided for accommodating a coolant and cooling the electrical lines 17a, 17b, 17c and the stator 4.

The electrical lines 17a, 17b, 17c are configured for conducting an electric current between a power electronics unit (not represented here) of the electric machine 1 and the stator 4. The three electrical lines 17a, 17b, 17c protrude radially from the electric machine 1 through a slot in the housing top 2d. The housing top 2d covers a portion of the flange-shaped section 3a, in order to fluidically insulate a section of the channel 8 that is located at the flange-shaped section 3a. An inflow 11 of the coolant into the channel 8 takes place via an axial inlet opening 19 at the first housing cover 2a. An outflow 12 of the coolant takes place via a radial outlet opening 20 in the second housing cover 2b.

The flange-shaped section 3a is axially preloaded, circumferentially, between the first housing cover 2a and the housing shell section 2c, wherein the flange-shaped section 3a has multiple axial passages 13 for accommodating screws. Each passage 13 is formed coaxially to a particular bore hole 14a in the first housing cover 2a and a particular bore hole 14b in the housing shell section 2c. A screw (not represented in the present case) extends through each of the bore holes 14a, 14b formed coaxially with respect to one another and a passage 13. By the screws, the preload and, as a result, a fluidic seal of the channel 8 at the flange-shaped section 3a are implemented. The second housing cover 2b is also screwed to the housing shell section 2c.

FIG. 2 shows the first housing cover 2a, the housing top 2d, and the plastic body 3, in which the stator 4 and the electrical lines 17a, 17b, 17c are embedded, in an exploded representation. From FIG. 2, it is apparent that the channel 8 is helically formed at an outer circumferential surface of the plastic body 3, wherein the coolant is guided between the housing shell section 2c and the plastic body 3 (see FIG. 4).

FIG. 3 shows a detailed representation in the area of the electrical lines 17a, 17b, 17c, which protrude radially from the flange-shaped section 3a of the plastic body 3, wherein the plastic body 3 partially encases the electrical lines 17a, 17b, 17c in this area. Multiple arrows P are shown in order to represent the coolant flow in a simplified manner. As explained above with reference to FIG. 1, the coolant flows via the inlet opening 19 in the first housing cover 2a into the channel 8 at the plastic body 3, wherein the channel 8 is formed radially in an outer circumferential surface at the flange-shaped section 3a of the plastic body 3 and is configured for guiding the coolant between the plastic body 3 and the housing top 2d (not represented in the present case). The channel 8 is formed in the plastic body 3 in such a way that the electrical lines 17a, 17b, 17c are surrounded on two sides by the channel 8 at the flange-shaped section 3a and, thereby, are cooled on both sides and over a large area. For this purpose, the coolant initially flows along a front side of the electrical lines 17a, 17b, 17c, is then diverted by one hundred and eighty degrees (180°) and flows along a back side of the electrical lines 17a, 17b, 17c. Subsequent thereto, the coolant is guided through the channel 8 further, circumferentially, along an end face 9a of first winding overhangs 7a of the stator 4 and, thereafter, via the helical section of the channel 8 along the outer circumferential surface 10 of the stator 4 toward an end face 9b of second winding overhangs 7b of the stator 4 (see FIG. 4).

According to FIG. 4, the electric machine 1 is represented in a half section. The stator 4, the rotor 5, which is arranged radially within the stator 4 and is rotatable about an axis of rotation A, and the electrically insulating plastic body 3 are arranged in the housing 2 of the electric machine 1, wherein the stator 4 is stationarily accommodated at the housing 2 by the plastic body 3. This is the case because the stator 4 is extrusion-coated with the plastic body 3 and the plastic body 3 is preloaded, via the flange-shaped section 3a, between the first housing cover 2a and the housing shell section 2c and, thereby, stationarily fixed. The channel 8, which is provided for accommodating the coolant, is formed in the plastic body 3, in order to cool the stator 4 when the coolant flows through the channel 8. The plastic body 3 has thermally conductive fillers in order to increase its thermal conductivity. The plastic body 3 surrounds a soft magnetic core 6 of the stator 4 on the end faces and radially on the outside. Moreover, the plastic body 3 also surrounds first and second winding overhangs 7a, 7b of the stator 4 on the end faces and radially. In the present case, the plastic body 3 is formed as one piece from an injection molding. By the plastic body 3, the electrical parts of the stator 4 are insulated and simultaneously cooled via the channel 8 formed in the plastic body 3 and the coolant (not represented here) guided in the channel 8. The channel 8 has a larger volume for coolant at the first winding overhangs 7a than the channel 8 at the second winding overhangs 7b. An axial width of the channel 8 at the outer circumferential surface 10 of the stator 4 is approximately six (6) times as great as a radial depth of the channel 8 at the outer circumferential surface 10 of the stator 4. The channel 8 is formed as an indentation in the outer surface of the plastic body 3 and is configured for guiding the coolant between the housing 2 and the plastic body 3.

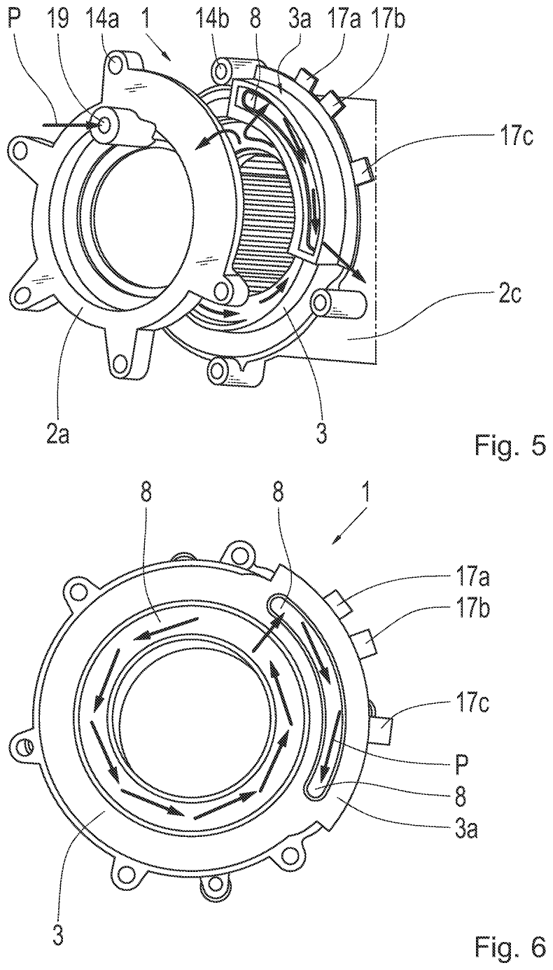

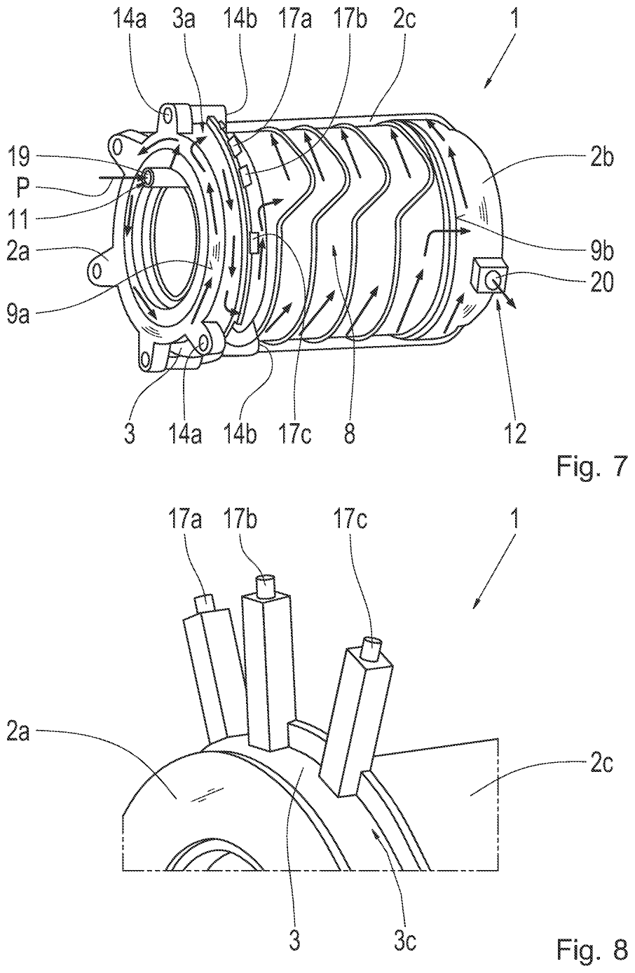

In FIG. 5, FIG. 6, and FIG. 7, a second exemplary embodiment of the electric machine 1 is represented. The second exemplary embodiment differs from the first exemplary embodiment by the formation of the channel 8 in the plastic body 3 and, thereby, by the coolant flow. Multiple arrows P are shown in order to represent the coolant flow in a simplified manner. The coolant flows via an inlet opening 19 in the first housing cover 2a into the channel 8 at the plastic body 3, wherein the channel 8 is axially formed in an end face of the plastic body 3 and is configured for circumferentially guiding the coolant between the first housing cover 2a and the plastic body 3, in order to initially cool first winding overhangs 7a of the stator 4, wherein the winding overhangs 7a are identical to the winding overhangs 7a according to the first exemplary embodiment. Thereafter, the coolant flows in a further section of the channel 8 and is guided along the electrical lines 17a, 17b, 17c in order to cool them. Consequently, the channel 8 is formed in the plastic body 3 in such a way that the electrical lines 17a, 17b, 17c at the flange-shaped section 3a are arranged on one side at the channel 8 and, thereby, are cooled on one side. Subsequent thereto, the coolant is guided via the helical section of the channel 8 along the outer circumferential surface 10 of the stator 4 (see FIG. 7).

The flange-shaped section 3a is axially preloaded, circumferentially, between the first housing cover 2a and the housing shell section 2c and, thereby, is form-lockingly connected thereto. Bore holes 14a are formed in the first housing cover 2a and bore holes 14b are formed in the housing shell section 2c for the purpose of axial preloading, wherein screws (not represented here) extend through each of these bore holes 14a, 14b. The preload enables a fluidic sealing of the channel 8 at the flange-shaped section 3a.

In FIG. 7, the electric machine 1 is perspectively represented, wherein the housing shell section 2c is transparently represented. As mentioned above, the inflow 11 for the coolant is formed at the end face 9a of the first winding overhangs 7a, wherein the coolant flows in via an inlet opening 19 formed axially in the first housing cover 2a. An outflow 12 for the coolant is formed at the end face 9b of the second winding overhangs 7b, wherein the coolant flows out via an outlet opening 20 formed radially in the second housing cover 2b. The channel 8 formed between the housing 2 and the plastic body 3 is utilized for the forced guidance of the coolant from the inlet opening 19 up to the outlet opening 20.

The arrows P illustrate that the coolant flows into the channel 8 via the inlet opening 19 and is guided in a circle circumferentially along the end face 9a of the first winding overhangs 7a. Subsequent thereto, the coolant flows along the electrical lines 17a, 17b, 17c in order to cool the electrical lines 17a, 17b, 17c as well. The coolant flows further through a helically designed section of the channel 8 four (4) times circumferentially along an outer circumferential surface 10 of the stator 4. Finally, the coolant flows through the channel 8 in the circle circumferentially along the end face 9b of the second winding overhangs 7b and out of the channel 8 via the outlet opening 20. The temperature of the coolant is minimal in the area of the inflow 11 at the first winding overhangs 7a, wherein the temperature continuously increases as the coolant flows through the channel 7 and reaches a maximum value in the area of the outflow 12 at the second winding overhangs 7b. Consequently, the first winding overhangs 7a and the three electrical lines 17a, 17b, 17c are cooled to a greater extent than the second winding overhangs 7b. In the present case, the winding overhangs 7a, 7b are extrusion-coated with the plastic body 3 and, therefore, are not represented. However, the winding overhangs 7a, 7b are identical to the winding overhangs 7a, 7b according to the first exemplary embodiment.

FIG. 8 shows a third exemplary embodiment of the electric machine 1, wherein, in the present case, a cutout of the flange-shaped section 3a is represented and, in fact, in the area of the electrical lines 17a, 17b, 17c. The electrical lines 17a, 17b, 17c protrude radially from the flange-shaped section 3a and the plastic body 3 separately encases each of the three electrical lines 17a, 17b, 17c in this area. The electrical lines 17a, 17b, 17c have a circular cross-section, wherein the plastic body 3 has a rectangular cross-section in this area.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 electric machine
2 housing
2a first housing cover
2b second housing cover
2c housing shell section
3 plastic body
3a flange-shaped section of the plastic body
4 stator
5 rotor
6 soft magnetic core
7a first winding overhangs
7b second winding overhangs
8 channel
9a end face of the first winding overhangs
9b end face of the second winding overhangs
10 outer circumferential surface
11 inflow
12 outflow
13 axial passage
14a bore hole
14b bore hole
17a electrical line
17b electrical line
17c electrical line
19 inlet opening
20 outlet opening
A axis of rotation
P arrow

1-15: (canceled)

16. An electric machine (1), comprising:
a multi-piece housing (2);
a stator (4) stationarily accommodated at the multi-piece housing (2) by a plastic body (3), the plastic body (3) being electrically insulating and surrounding at least one electrical line (17a, 17b, 17c) configured for conducting an electric current between a power electronics unit of the electric machine (1) and the stator (4), at least one channel (8) being formed in the plastic body (3) and configured for accommodating a coolant; and
a rotor (5) arranged radially within the stator (4),
wherein a flange-shaped section (3a) of the plastic body (3) is positioned axially between a first housing cover (2a) and a housing shell section (2c) of the multi-piece housing (2), and the at least one electrical line (17a, 17b, 17c) and the at least one channel (8) are formed in the flange-shaped section (3a).

17. The electric machine (1) of claim 16, wherein the flange-shaped section (3a) is axially preloaded, circumferentially, between the first housing cover (2a) and the housing shell section (2c).

18. The electric machine (1) of claim 16, wherein:
the flange-shaped section (3a) defines a plurality of axial passages (13) for screws; and
each of the axial passages (13) is formed coaxially to a respective bore hole (14a) in the first housing cover (2a) and a respective bore hole (14b) in the housing shell section (2c).

19. The electric machine (1) of claim 16, wherein the at least one channel (8) is formed as an indentation in an outer surface of the plastic body (3).

20. The electric machine (1) of claim 16, wherein the at least one channel (8) is axially formed in an end face of the plastic body (3) and is configured for guiding the coolant between the first housing cover (2a) and the plastic body (3).

21. The electric machine (1) of claim 16, wherein the at least one channel (8) is radially formed in an outer circumferential surface of the plastic body (3) and is configured for guiding the coolant between the plastic body (3) and a housing top (2d).

22. The electric machine (1) of claim 16, wherein the at least one channel (8) is formed in the plastic body (3) such that the at least one electrical line (17a, 17b, 17c) is at least partially surrounded on two sides by the at least one channel (8).

23. The electric machine (1) of claim 16, wherein the at least one electrical line (17a, 17b, 17c) protrudes radially from the flange-shaped section (3a), and the plastic body (3) at least partially encases the at least one electrical line (17a, 17b, 17c) proximate the flange-shaped section (3a).

24. The electric machine (1) of claim 23, wherein the at least one electrical line (17a, 17b, 17c) comprises three electrical lines (17a, 17b, 17c) that protrude radially from the flange-shaped section (3a), and the plastic body (3) separately encases each of the three electrical lines (17a, 17b, 17c) proximate the flange-shaped section (3a).

25. The electric machine (1) of claim 16, wherein:
the plastic body (3) surrounds a magnetic core (6) of the stator (4);
the plastic body (3) surrounds first and second winding overhangs (7a, 7b) of the stator (4) at end faces of the first and second winding overhangs (7a, 7b); and
the plastic body (3) extends radially over the end faces of the first and second winding overhangs (7a, 7b).

26. The electric machine (1) of claim 25, wherein:
the at least one channel (8) is at least partially formed, circumferentially, along the end face (9a) of the first winding overhangs (7a);
the at least one channel (8) is formed, repeatedly circumferentially, along an outer circumferential surface (10) of the stator (4); and
the at least one channel (8) is at least partially formed, circumferentially, along the end face (9b) of the second winding overhangs (7b).

27. The electric machine (1) of claim 26, wherein an axial width of the at least one channel (8) at the outer circumferential surface (10) of the stator (4) is at least three times larger than a radial depth of the at least one channel (8) at the outer circumferential surface (10) of the stator (4).

28. The electric machine (1) of claim 26, wherein the at least one channel (8) is helically wound along the outer circumferential surface (10) of the stator (4) and is configured for guiding the coolant between the housing shell section (2c) and the plastic body (3).

29. The electric machine (1) of claim 25, wherein an inflow (11) for the coolant is formed at the end face (9a) of the first winding overhangs (7a), and an outflow (12) for the coolant is formed at the end face (9b) of the second winding overhangs (7b).

30. The electric machine (1) of claim 16, wherein the plastic body (3) comprises thermally conductive fillers.
